(19) United States
(12) Patent Application Publication
(10) Pub. No.: US 2008/0232208 A1
(43) Pub. Date: Sep. 25, 2008

(54) High Frequency Central Aperture Tracking

(75) Inventors: Alexander Marc Van Der Lee, Eindhoven (NL); Dominique Maria Bruls, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 12/064,085

(22) PCT Filed: Aug. 16, 2006
(86) PCT No.: PCT/IB2006/052824

§ 371 Date: Feb. 19, 2008

(30) Foreign Application Priority Data
Aug. 22, 2005 (EP) 05107687.5

(51) Int. Cl. G11B 7/09

(52) U.S. Cl. 369/44.37

(57) ABSTRACT

The present invention relates to an optical system for performing radial tracking on an associated optical record carrier. The optical system contains at least one radiation-emitting device capable of emitting at least three beams: a first beam for reading and/or recording information, and at least a second beam and a third beam for tracking. The optical system is adapted for radial tracking of the first spot from a tracking error signal generated based on the high-frequency component of the central-aperture signal of the second and third beams. The tracking error signal may be generated based on a difference signal of a DC-level of the power of the high-frequency components of the central-aperture signal.

The present invention relates to an optical system for reproducing and/or recording optically readable effects on an associated optical record carrier and performing radial tracking on the optical record carrier. The invention further relates to a method of tracking a beam of an optical system, moreover the invention relates to software for implementing the method, and to a unit for generating a tracking signal.

In order to meet a demand of increasing information storage capacity as well as speed, the available optical media, e.g. compact disc (CD), digital versatile disc (DVD) and the Blu-ray Disc (BD), show a constant improvement in storage capacity as well as in reading and recording speed. In the course of fulfilling the demand of facilitating improved storage means, also improved tracking methods are required.

Conventionally radial tracking is done by monitoring the DC value (low frequency part) of a radial tracking error signal. In the published Japanese patent application JP 2002-216378 a tracking error detection device is disclosed where the tracking error signal is detected by high-frequency push-pull signals of sub-beams reflected from a media comprising tracks arranged in a groove meander structure.

Radial tracking based on push-pull signals may suffer from beam landing problems, i.e. problems related to an offset in the push-pull signal due to decentring of the detector with respect to the impinging beam; whereas a groove meander structure may impede a low track pitch.

The inventor of the present invention has appreciated that means for improved radial tracking is of benefit, and has in consequence devised the present invention.

The present invention seeks to improve the tracking performance of optical storage systems. Preferably, the invention alleviates, mitigates or eliminates one or more of the above or other disadvantages singly or in any combination.

Accordingly there is provided, in a first aspect, an optical system for reproducing and/or recording optically readable effects arranged along tracks on an associated optical record carrier, the system comprising:
at least one radiation-emitting device capable of emitting
a first beam and a corresponding first spot for reading and/or recording information as readable effects in the carrier, and
at least a second beam and a third beam and corresponding second and third spots, the second spot being displaced in a first direction with respect to the first spot, and the third spot being displaced in a second direction with respect to the first spot,
a photodetector capable of detecting reflected radiation from the optical record carrier,

wherein the optical system is adapted for radial tracking of the first spot from a tracking error signal generated based on the high-frequency (HF) component of the central-aperture (CA) signal of the radiation reflected from the second and third spots.

The optical system may be an optical system for use in such apparatuses as CD-players, DVD-players, BD-player, optical computer drives, etc. The optical system comprises at least one radiation source. The radiation source may be at least one radiation emitting device capable of emitting at least three beams: one beam for reading and/or recording data from/to a data carrier, and two beams (the second and third beam) for generating a radial tracking signal. The second and third beams need not exclusively be used for tracking purposes, but also e.g. for reproducing data. The invention is mainly directed towards reading and/or recording information from/to a data carrier that already comprises data thereon, since the tracking of the first spot is obtained from HF-components of CA-signals. Recording of data may e.g. be performed in a direct over write (DOW) situation where old data is replaced by new data in a single passage of a data track. However, the invention is also applicable for tracking in a recording situation on a “blank” carrier if a HF-signal can be read from the carrier, e.g. from data or tracking marks preformed on the disc.

The invention according to the first aspect is particularly, but not exclusively advantageous for a number of reasons. A first advantage may relate to that by generating a tracking error signal based on the high-frequency component of the central-aperture signal (CA-signal) of the radiation reflected from the second and third spots, a tracking error signal in a different frequency domain than the focus error signal may be provided since the focus error signal is a low frequency signal. It may thus be possible to eliminate, or at least reduce, problems relating to cross-talk in the focus and an radial tracking signals, thereby providing a more stable system. A further advantage may be that by basing the tracking error signal on the CA-signal, problems relating to beam landing may be avoided, or at least reduced. An even further advantage in this respect, is that a split photodetector can be avoided. A split photodetector is needed when using push-pull tracking. It should, however, be noted that the photodetector may be split for other purposes, such as for focus tracking, the advantage may therefore be related to avoiding coupling the different segments together in halves, as well as the accompanying circuitry. An even further advantage may relate to that the optical system may be applicable for both single track read-out as well as multi-track read-out—thereby providing a versatile system.

The optional features as defined in claims 2 and 3 are advantageous for generating a tracking error signal in an embodiment where the first beam is used for data read-out, whereas the second and third beams are tracking beams.

The optional features as defined in claim 4 are advantageous for generating a tracking error signal in an embodiment where at least the first, second and third beams are used for data read-out, the second and third beams concurrently being used for radial tracking of the first beam.

The optional features as defined in claims 5 and 6 are advantageous since by basing the tracking error signal on a difference signal of the power, or of the DC-level of the power, of the high-frequency components of the central-aperture signal no, or only little, signal processing is necessary for generating the tracking error signal to be used in the tracking loop circuit, thereby providing a stable and cost-effective system.

According to a second aspect of the invention is provided a unit for generating a tracking error signal, the unit comprising:
an input section for connection to one or more photodetectors capable of detecting reflected radiation from an associated optical record carrier, the input section receiving input signals representing radiation incident on the photodetector, the input signals including:
a first signal representing a first incident beam, the first incident beam being a beam for reading and/or recording information as readable effects in the carrier,
at least a second and a third signal representing at least a second incident beam and a third incident beam, the at least second and third incident beams being displaced in a first and second direction on the associated carrier with respect to the first beam, an output section for outputting a tracking signal, and
a processing unit for generating the tracking error signal based on the detected reflected radiation,

wherein the tracking error signal is adapted for radial tracking of the first beam, the tracking error signal being generated based on the high-frequency component of the central-aperture signal of the radiation of the second and third incident beams, as inputted at the input section.

This aspect of the invention is particularly, but not exclusively, advantageous in that the present invention may be implemented in some known optical system, and thereby changing the operation of the known system, so that from only minor changes in a known system may the operation of the system be brought into accordance with the various aspects of the present invention.

In a third aspect, the present invention relates to a method of operating an optical system according to the first aspect of the invention, wherein the tracking, in a situation of use, is performed by use of a tracking error signal based on the high-frequency component of the central-aperture signal of the radiation reflected from the associated carrier.

In a fourth aspect, the present invention relates to software executable on computing hardware for implementing a method according to the third aspect.

This aspect of the invention is particularly, but not exclusively, advantageous in that the present invention may be implemented in some known optical system, by implementing the method of the third aspect in computing hardware controlling the operation of an optical system. The implementation in a known system may possible be done concurrently with the implementation of a unit according to the second aspect of the invention.

In general the various aspects of the invention may be combined and coupled in any way possible within the scope of the invention. These and other aspects, features and/or advantages of the invention will be apparent from and elucidated with reference to the embodiments described hereinafter.

Embodiments of the invention will be described, by way of example only, with reference to the drawings, in which

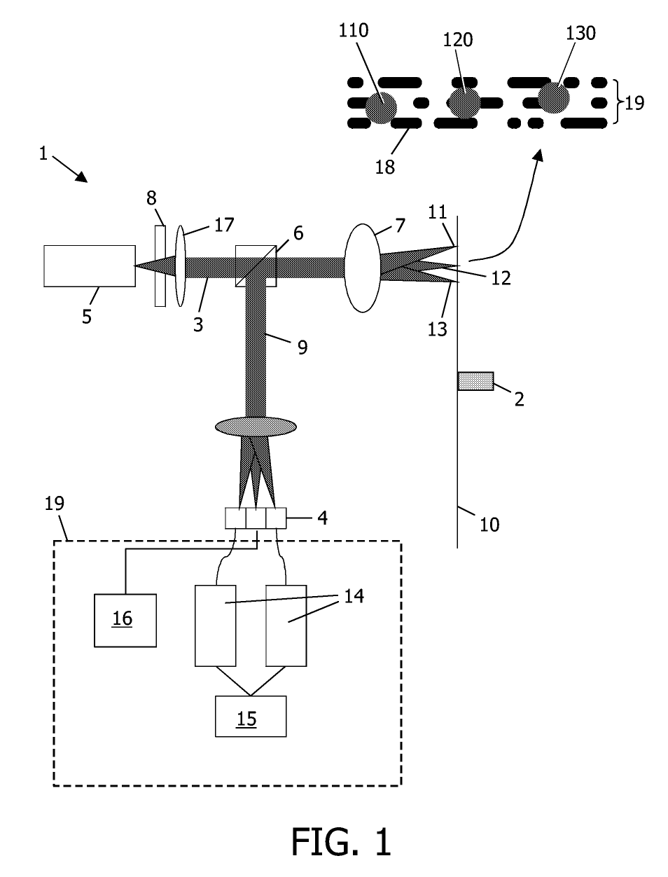

FIG. 1 schematically illustrates an embodiment of an optical system and associated carrier,

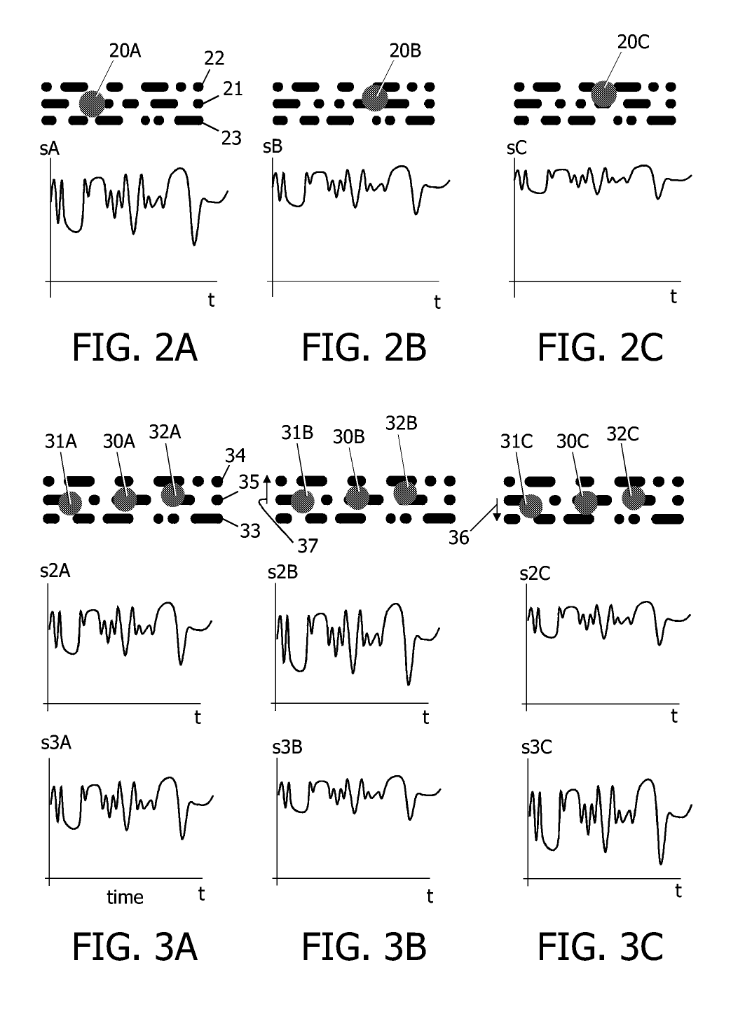

FIG. 2 shows a schematic illustration of a HF-signal as function of radial displacement of a single spot on the carrier,

FIG. 3 schematically illustrates HF-signals as a function of radial displacement in a situation where two side spots are used.

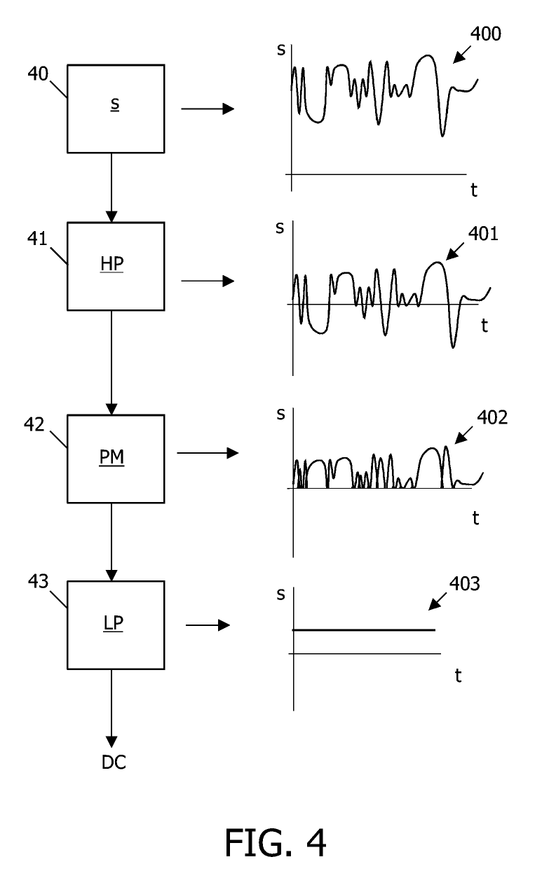

FIG. 4 schematically illustrates a method of transforming the CA-signal into a DC-signal representing the HF-content of the CA-signal,

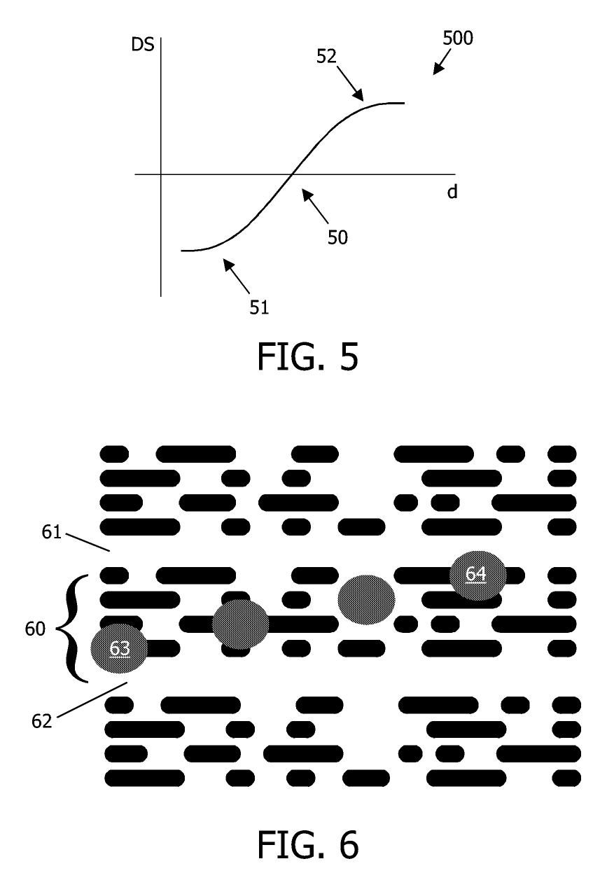

FIG. 5 illustrates a schematic tracking error signal, and

FIG. 6 schematically illustrates as tracking situation on a carrier with a meta-track structure.

An embodiment of an optical system 1 and associated carrier 10 is schematically illustrated in FIG. 1. The carrier 10 is fixed and rotated by holding means 2. The carrier 10 comprises a material suitable for recording information by means of a radiation beam 3. The carrier may be any type of carrier suitable for use in an optical system where information may be recorded in the form of readable effects, i.e. optically detectable regions, also called marks for rewriteable media and pits for write-once media. The optical effects 18 are arrange along spiral tracks 19. Here, a section showing three tracks is illustrated.

The optical system comprises a photodetector, or photodetector system 4, here illustrated as a 3-spot photodetector, a radiation source 5, such as a laser, a beam splitter 6, an objective lens 7, and a collimator 17. The optical system also comprises beam dividing means 8, such as a grating or a holographic pattern that is capable of splitting the radiation beam 3 into at least three components 11, 12 and 13, i.e. a first beam for reading and/or recording information in the carrier, and a second and a third beam being displaced with respect to the first beam. The beams being focused on the carrier in first 120, second 110 and third spots 130. The beams 11, 12 and 13 may e.g. be a high intensity main beam and two low intensity auxiliary, or side, beams. The auxiliary beams 11 and 13 may be the diffraction beams of a given order. The beams are reflected from the optical carrier and directed towards the photodetector, and the reflected radiation 9 also comprises more than one component, i.e. the reflections of the three beams 11, 12, and 13.

In this embodiment, the radiation source in combination with the beam dividing means (or grating) constitutes the radiation-emitting device. This is a cost effective way of designing the radiation-emitting device capable of emitting at least three beams. Equivalent means may however be envisioned, such as an array of laser diodes where each diode may be capable of emitting radiation with different or the same intensity.

The function of the photodetector 4 is to convert radiation 9 reflected from the carrier 10 into electrical signals. The photodetector, or part of the detector may comprise more than one photosensitive area, be build up of smaller detector units, as in this embodiment where three are present, or be constructed in any given way for detecting the radiation in an appropriate manner. Some (or all) of the photosensitive areas constituting the photodetector, may be segmented so as to enable detection of both focus and radial tracking errors. The photodetector signals, such as first, second and third signals, representing the radiation beams incident on the detector may be inputted at an input section of a unit 19. The second and third beams are communicated to one or more elements 14 for measuring the HF-power of the second and third beams. The HF-power measurement is inputted into a processing unit 15 that transforms the HF-power to a DC-level and the signal of the auxiliary spots is subtracted from each other, thereby generating a tracking error signal, such as a radial S-curve. The tracking error signal is communicated towards the radial tracking servo.

The photodetector 4 also transmits the read signal, or first signal (RF signal representing the information being read from the carrier 10) to an element 16. The element 16, may be a processing unit, or a unit for directing the read signal to a processing unit for extracting and treating the information read from the carrier.

FIG. 2 shows a schematic illustration of HF-signals as function of radial displacement of a single spot on the carrier. In FIGS. 2A-2C are the measured HF-signal, sA, Sb and sC, plotted as a function of time, t, for three different situation. In FIG. 2A is the radiation spot 20A centered on the center track 21, giving rise to a large amplitude in the HF-signal, or correspondingly in the measured HF-power. Reference to center, upper, lower and the like should not be construed as reference to a given geometry on the carrier; such reference is only made for illustrative purposes. In FIG. 2B is the radiation spot 20B off-center with respect to the track 21. The spot 20B is displaced towards an adjacent (upper) track 22, giving rise to a smaller amplitude in the HF-signal than for the situation in FIG. 2A, since the central part of the radiation spot cover more land region, than compared to the situation of FIG. 2A where the central part of the spot covers the track. In FIG. 2C is the radiation spot 20C off-center to a larger degree with respect to the track 21, as compared to the situation of FIG. 2B. The spot 20C is here centered in the land region between the center track and the adjacent (upper) track 22, giving rise to an even smaller amplitude in the HF-signal as compared to the situations in FIG. 2A and FIG. 2B.

FIG. 3 schematically illustrates HF-signals as a function of radial displacement in a situation where two side spots are used. FIG. 3 thus schematically illustrates a “twin-spot tracking”-type method of the present invention. The spots denoted 30A, 30B and 30C are the corresponding spot of a first beam for reading and/or recording information as readable effects in the carrier, whereas the spots denoted 31A, 31B, 31C, 32A, 32B and 32C are the corresponding spots of second and third beams, the second spot being displaced in a first direction with respect to the first spot, i.e. toward the lower adjacent track 33, and the third spot being displaced in a second direction with respect to the first spot, i.e. toward the upper adjacent track 34. The displacements of the second and third spots are along directions orthogonal to an extending direction of a track, i.e. in a direction either towards an adjacent track on one side 35, or towards an adjacent track on the other side 36. The size of the displacement may be is a fraction of a spacing between adjacent tracks. In this embodiment, the size of displacement is ¼ of the spacing between adjacent tracks. This is advantageous since for ¼ displacement maximum sensitivity of the amplitude variations with respect to off-track movement is achieved.

In FIGS. 3A-3C are the measured HF-signals plotted as a function of time, t, for three different situation for the second and third spots. The signals s2A, S2B, s2C illustrate the signals relating to the second spot 31A, 31B, 31C and the signals s3A, s3B, s3C illustrate the signals relating to the third spot 32A, 32B, 32C.

FIG. 3A illustrates a situation where the radiation spot 30A is centered on the center track 35 and the second 31A and third spots 32A are displaced ¼ of a track on opposite sides of the center track 35. The HF-signals from each of the side spots are similar to the situation of FIG. 2B, i.e. each spot gives rise to a medium amplitude in the HF-signal. Since the signals are similar they cancel each other out when subtracted. In FIG. 3B is illustrated a situation where the center spot is off-track in an upward direction as indicated by the arrow denoted 37. Since the side spots are coupled to the center spot the side spots 31B and 32B both move in the same direction and with the same amount as the center spot. The second spot 31B moves towards the center track, resulting in that the amplitude of the corresponding HF-signal s2B increases, whereas the third spot 32B moves toward land area in between the center track 35 and the upper adjacent track 34, resulting in that the amplitude of the corresponding HF-signal s3B decrease. An asymmetry is present in the side spot signals in this situation, so that a difference signal becomes positive. In FIG. 3C is illustrated a situation where the center spot is off-track in a downward direction as indicated by the arrow denoted 36. In this situation, the second spot 31C moves away from the center track, and the amplitude of the corresponding HF-signal s2C decreases, whereas the third spot 32C moves toward the center track 35 and the amplitude of the corresponding HF-signal s3C decreases, so that a difference signal becomes negative.

The HF-component of the CA-signals reflected from the second and third spots is used for generating a tracking error signal. The tracking error signal may be generated based on a difference signal of a DC-level of the power of the high-frequency components of the central-aperture signal. The signals s2A-s3C may be transformed into a DC-signal representing the HF-content by a method as illustrated in FIG. 4.

The CA-signal 400 as detected on the photodetector is first transformed by means of a high-pass filter HP so that a possible off-set of the signal is removed 401. The high-pass transformed signal is then squared resulting in a power measurement of the signal PM, 402. The power signal 402 is subsequently transformed by means of a low-pass filter LP so as to provide a DC-signal DC, 403 representing the HF-content of the CA-signal. The method may include further steps, or alternative steps to those described. For example may the method include normalization of initial signals, of intermediate signals and/or of resulting signals. The sampling of the DC-signal representing the HF-content may be performed with a frequency depending on a situation of use, the sampling rate may be in the kHz or MHz range.

FIG. 5 illustrates a schematic tracking error signal 500 that may be obtained in accordance with the presented invention. The tracking error signal is a so-called S-curve, showing a difference signal DS as a function of a tracking error, or spot displacement, d, with respect to a center position of a track.

In a situation as illustrated in FIG. 3A where the main spot is centered on the track, the HF-signals from each of the side spots are similar, and consequently the DC-signal representing the HF-content (FIG. 4) are also similar, and the difference signal of the side spots cancel each other out, resulting in a difference that is small or zero 50. In a situation where the center spot is off-track in an upward direction as illustrated in FIG. 3B an asymmetry is present in the side spot HF-signals so that a difference signal becomes positive 52, and vice versa in a situation where the center spot is off-track in a downward direction as in FIG. 3C, except that the difference signal becomes negative 51. By driving the tracking servo so that the difference signal is stabilized around zero 50, the first radiation beam remains on-track.

FIG. 6 schematically illustrate as tracking situation on a meta-track structure, such as a TwoDOS type format. A meta track 60 consists of several bitrows that are separated from the next meta track by a somewhat larger region of empty track, also referred to as a guard band 61, 62. Thus one meta track is sandwiched between a first guard band 61 and a second guard band 62. The carrier format may consist of a plurality of tracks disposed substantially spirally and substantially concentrically with respect to central position on the carrier. The number of tracks within the meta track is in FIG. 6 four, however any suitable number may be envisioned, in particular: 2, 3, 4, 5, 6, 7, 8, 10, 11, 12, 13, 14, 15, 16, 17, 18, 19, and 20. The number of radiation sources is equal to the number of tracks so that parallel read-out of the entire meta track is obtained. The radiation sources are coupled together, so that if one spot moves off track, all spots move off tracks. The situation is therefore similar to the situation as illustrated in FIGS. 3 and 4, since if the bundle of spots is moving in an upward direction, the spot denoted 63 moves towards the higher data density of the adjacent track, whereas the spot dented 64 moves toward lower data density of the guard band, and vice versa for spot movements in the opposite direction. By using the HF-component of the CA-signal reflected form the outer spots 63, 64, next to a guard band, i.e. the outer spots are in this embodiment the second and third spots, tracking of the entire bundle of spots can be obtained without need for additional spots. The CA-signal of the outer spots 63, 64 can in this embodiment concurrently be used for reading data and for radial tracking.

Although the present invention has been described in connection with preferred embodiments, it is not intended to be limited to the specific form set forth herein. Rather, the scope of the present invention is limited only by the accompanying claims.

In this section, certain specific details of the disclosed embodiment are set forth for purposes of explanation rather than limitation, so as to provide a clear and thorough understanding of the present invention. However, it should be understood readily by those skilled in this art, that the present invention may be practized in other embodiments which do not conform exactly to the details set forth herein, without departing significantly from the spirit and scope of this disclosure. Further, in this context, and for the purposes of brevity and clarity, detailed descriptions of well-known apparatus, circuits and methodology have been omitted so as to avoid unnecessary detail and possible confusion.

Reference signs are included in the claims, however the inclusion of the reference signs is only for clarity reasons and should not be construed as limiting the scope of the claims.

1. An optical system (1) for reproducing and/or recording optically readable effects (18) arranged along tracks (19, 60) on an associated optical record carrier (10), the system comprising:
at least one radiation-emitting device (5) capable of emitting
a first beam (12) and a corresponding first spot (120) for reading and/or recording information as readable effects in the carrier, and
at least a second beam (11) and a third beam (13) and corresponding second and third spots (110,130), the second spot being displaced in a first direction (35) with respect to the first spot, and the third spot being displaced in a second direction (36) with respect to the first spot,
a photodetector (4) capable of detecting reflected radiation from the optical record carrier,
wherein the optical system is adapted for radial tracking of the first spot from a tracking error signal (500) generated based on the high-frequency component of the central-aperture signal (400) of the radiation reflected from the second and third spots.

2. An optical system according to claim 1, wherein a size of a displacement of the second and third spots along a direction orthogonal to an extending direction of a track, is a fraction of a spacing between adjacent tracks.

3. An optical system according to claim 2, wherein the fraction is ¼ of the spacing between adjacent tracks.

4. An optical system according to claim 1, adapted for tracking on an associated optical record carrier comprising readable effects arranged in tracks (60) in one or more spirals, the one or more spirals being separated by guard bands, wherein the second spot (64) is placed on a track being adjacent to a first guard band (61), and wherein the third spot (63) is placed on a track being adjacent to a second guard band (62).

5. An optical system according to claim 1, wherein tracking error signal generated based on a difference signal of the power of the high-frequency components of the central-aperture signal of the radiation reflected from the second and third spots.

6. An optical system according to claim 1, wherein the tracking error signal is generated based on a difference signal of a DC-level (403) of the power of the high-frequency components of the central-aperture signal of the radiation reflected from the second and third spots.

7. Unit (19) for generating a tracking error signal, the unit comprising:
an input section for connection to a photodetector (4) capable of detecting reflected radiation from an associated optical record carrier (10), the input section receiving input signals representing radiation incident on the photodetector, the input signals including:
a first signal representing a first incident beam (12), the first incident beam being a beam for reading and/or recording information as readable effects (18) in the carrier,
at least a second and a third signal representing at least a second incident beam (11) and a third incident beam (13), the at least second and third incident beams being displaced in a first and second direction (35,36) on the associated carrier with respect to the first beam,
an output section for outputting a tracking signal, and
a processing unit (15) for generating the tracking error signal based on the detected reflected radiation,
wherein the tracking error signal is adapted for radial tracking of the first beam, the tracking error signal (500) being generated based on the high-frequency component of the central-aperture signal (400) of the radiation of the second and third incident beams, as inputted at the input section.

8. A method of tracking a beam of an optical system (1) for reproducing and/or recording optically readable effects arranged along tracks (19,60) on an associated optical record carrier (10), the system comprising:
at least one radiation-emitting device (4) capable of emitting
a first beam (12) and a corresponding first spot (120) for reading and/or recording information as readable effects in the carrier, and
at least a second beam (11) and a third beam (13) and corresponding second and third spots (110,130), the second spot being displaced in a first direction (35) with respect to the first spot, and the third spot being displaced in a second direction (36) with respect to the first spot,
a photodetector (4) capable of detecting reflected radiation from the optical record carrier,
wherein the method comprising the steps of:
generating a tracking error signal (500) based on the high-frequency component of the central-aperture signal (400) of the radiation reflected from the second and third spots.
tracking the first beam along a given track on an associated optical record carrier by use of the tracking error signal.

9. Software executable on computing hardware for implementing a method as claims in claim 8.
